(19) United States
(12) Patent Application Publication
(10) Pub. No.: US 2006/0170615 A1
(43) Pub. Date: Aug. 3, 2006

(54) Pen type virtual display

(75) Inventor: Tapani Levola, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/322,167

(22) Filed: Dec. 28, 2005

(30) Foreign Application Priority Data
Dec. 31, 2004 (FI) FI20045513

(51) Int. Cl. G09G 5/00

(52) U.S. Cl. 345/8

(57) ABSTRACT

The invention relates to a display module, a portable device comprising a display module, and a method of displaying graphical information. A virtual image is generated using a micro-display, imaging optics and a diffractive beam expander. The virtual image is observable through the exit aperture of the diffractive beam expander. The aspect ratio of the displayed virtual image is substantially different from the aspect ratio of the exit aperture. A visible portion of the displayed image may be selected by tilting the display module. Thus, e.g. an entire displayed page of text may be examined through a wide but low display module, viewing two or three lines of text at a time.

### CROSS-REFERENCE TO RELATED APPLICATIONS

This application claims priority under 35 USC §119 to Finnish Patent Application No. 20045513 filed on Dec. 31, 2004.

### FIELD OF THE INVENTION

The present invention relates to a display module to form a virtual image, said display module comprising at least a micro display, imaging optics, and a diffractive beam expander, said virtual image being adapted to be observable through an exit aperture of said diffractive beam expander. The present invention relates also to a device comprising a display module, and to a method to display an image.

### BACKGROUND OF THE INVENTION

Display modules are used in portable devices to display information in graphical form. Small size is an important aspect in portable devices. The small size of a portable device also sets a limitation to the size of a display module incorporated in said device. The drawback of small display modules is that, when viewing at a distance, an observer can examine only a small portion of a large displayed image at a glance, while preserving adequate resolution.

A visible portion of the image is typically selected using scroll buttons or a scroll knob. For example, when a page of text is examined, the portion of the text to be viewed may be selected by turning a scroll knob of a computer mouse.

Another approach to display a large detailed image using a small display module is to use a near-eye-display. An exit aperture of a small display module is brought close to the eye of an observer. However, some people find it slightly unpleasant to bring objects close to their eyes. A near eye display based on a diffractive beam expander is disclosed in patent application EP 0535402.

The aspect ratio of the exit aperture is typically selected to correspond to the aspect ratio of the displayed image. For example, when a display module is designed to display images with an aspect ratio 4:3, the aspect ratio of the exit aperture is typically substantially close to 4:3. The aspect ratio refers to the ratio of the width to the height.

### SUMMARY OF THE INVENTION

It is an object of the present invention to provide a small display module, which allows viewing a virtual image with high resolution. A further object of the present invention is to provide a portable device comprising said a display module. It is yet an object of the present invention to provide a method to display a virtual image.

According to a first aspect of the invention, there is a method to display a virtual image, said method comprising at least forming a virtual image by a micro display, imaging optics, and a diffractive beam expander, said virtual image being an image of the active area of said micro display, and said virtual image being observable through an exit aperture of said diffractive beam expander, wherein the aspect ratio of said virtual image is substantially different from the aspect ratio of said exit aperture.

According to a second aspect of the invention, there is a display module to form a virtual image, said display module comprising at least a micro display, imaging optics and a diffractive beam expander, said virtual image being an image of the active area of said micro display, and said virtual image being observable through an exit aperture of said diffractive beam expander, wherein the aspect ratio of said virtual image is substantially different from the aspect ratio of said exit aperture.

According to a third aspect of the invention, there is a portable device comprising a display module to form a virtual image, said display module in turn comprising at least a micro display, imaging optics and a diffractive beam expander, said virtual image being an image of the active area of said micro display, and said virtual image being observable through an exit aperture of said diffractive beam expander, wherein the aspect ratio of said virtual image is substantially different from the aspect ratio of said exit aperture.

A display module according to the present invention comprises a micro-display, imaging optics and a diffractive beam expander. The display module converts a real image formed by the micro-display to a virtual image, which is observable through an exit aperture of said diffractive beam expander. The dimensions of the exit aperture may be, for example 1×10 cm. The displayed image may be a page of text. The display module is advantageously positioned at 0.2-0.6 meters from the eyes of an observer, and from that distance two or three lines of text are visible at a glance. The examined text is selected by tilting the display module. In other words, the visible portion of the virtual image is selected by changing the angular orientation of a combination of the micro-display and the imaging optics with respect to an observer.

The image can be observed by keeping the display module far from the eye of an observer, i.e. at a distance greater than 0.1 meters. The display module or the portable device comprising such a display does not block the vision of an observer. The observer can see the environment while viewing the displayed image. Thus, the observer can even walk while viewing the displayed image.

The virtual image is formed at a distance, which is in the range from one meter to infinity. Thus, the virtual image is further away from the observer than the display module. Thus, the eyes of an observer do not need to accommodate to the physical distance of the display module.

Some people with hyperopia (farsightedness) do not need spectacles to examine the displayed image.

In general, people wearing spectacles appreciate that the display unit can be viewed at a distance.

The method of scrolling the image by tilting the entire device is user-friendly, and the observer learns the method in a short time.

The display and the device according to the present invention may be slim, and consequently easy to carry and to handle. The power consumption of the display module is small. The visual appearance of the displayed virtual image is exciting when compared with images displayed by conventional planar displays.

The embodiments of the invention and their benefits will become more apparent to a person skilled in the art through the description and examples given herein below, and also through the appended claims.

### BRIEF DESCRIPTION OF THE DRAWINGS

In the following examples, the embodiments of the invention will be described in more detail with reference to the appended drawings, in which

FIG. 1 shows schematically a display module according to the present invention comprising a diffractive beam expander and an optical engine,

FIG. 2 shows schematically optical rays transmitted from a micro-display through the diffractive beam expander, as seen from a direction parallel to the dimension W1 of an exit aperture of said diffractive beam expander,

FIG. 3a shows schematically the tilting of the exit aperture with respect to a horizontal axis,

FIG. 3b shows schematically the tilting of the exit aperture with respect to a vertical axis,

FIG. 4a shows schematically optical rays transmitted from a first point, as seen from a direction parallel to the dimension W2 of the exit aperture,

FIG. 4b shows schematically optical rays transmitted from the first point and from a second point, as seen from a direction parallel to the dimension W2 of the exit aperture,

FIG. 5a shows schematically how the projected dimension W1′ of the exit aperture defines the portion of the virtual image visible to an observer.

FIG. 5b shows schematically the angular dimensions of the virtual image and the exit aperture, and

FIG. 6 shows schematically a portable device comprising a display module according to the present invention.

### DETAILED DESCRIPTION OF THE INVENTION

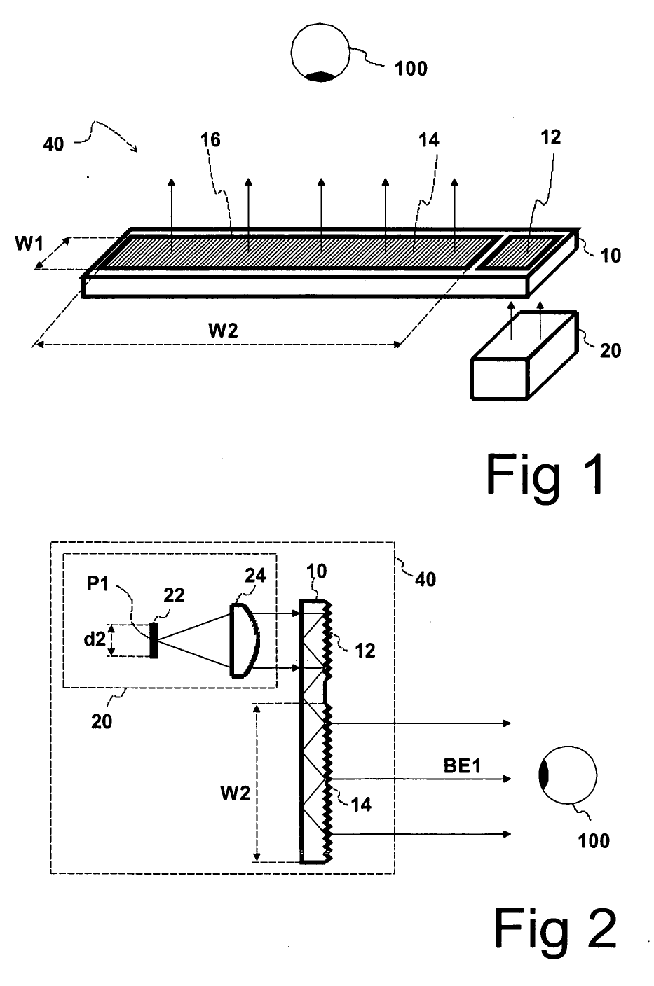

Referring to FIG. 1, a display module 40 according to the present invention comprises at least an optical engine 20 and a diffractive beam expander 10. The optical engine 20 transmits a plurality of light beams corresponding to the virtual image to be displayed. The aperture of the optical engine 20 is typically round or rectangular. The aperture is small, and therefore the light beam emitted from the optical engine 20 is expanded in at least one dimension using the diffractive beam expander 10. The expanded beam is further transmitted to the eye of the observer 100.

According to the present invention, the dimension W1 of the exit aperture 16 of the diffractive beam expander 10 may be small, and therefore it may be enough to expand the beam transmitted from the optical engine 20 only in one dimension, i.e. in the direction parallel to the dimension W2.

The beam expander comprises at least two diffractive elements 12, 14 arranged on a substantially planar transparent substrate. The perimeter of the second diffractive element 14 substantially defines the height W1 and the width W2 of the exit aperture 16, providing that the output aperture of the optical engine 20 is large enough. The exit aperture 16, in turn, defines the maximum height and width of the expanded light beam transmitted towards the observer 100.

Referring to FIG. 2, the optical engine 20 comprises a micro-display 22 and imaging optics 24. The imaging optics 24 may comprise one or more optical elements, such as lenses, mirrors, prisms or diffractive elements. Light rays transmitted by a point P1 of the micro-display 22 are collimated by the imaging optics 24 to form a parallel or a slightly diverting beam of light. The micro-display 22 is positioned such that the active pixels of the micro-display 22 are at the focal distance of the imaging optics 24. The active area of the micro-display 22 is defined by the area consisting of controllable pixels. The active area of the micro-display 22 has a dimension d2 substantially parallel to the dimension W2 of the exit pupil 16.

The beam transmitted from the optical engine 20 impinges on the first diffractive element 12 of the beam expander 10. The first diffractive element 12 diffracts light towards the second diffractive element 14. The light propagates inside the transparent beam expander 10 by a plurality of total internal reflections. The second diffractive element 14 diffracts an expanded beam of light BE1 towards the eye of the observer 100.

A real image formed by the pixels of the micro-display 22 is converted to a virtual image by the imaging optics 24. Each point of the micro-display 22 corresponds to a parallel or a slightly diverting beam of light transmitted from the exit aperture 16. Thus, the eye of the observer 100 sees a virtual image at a distance.

When using planar diffractive elements 12,14, the virtual image is formed at infinite distance. However, the distance between the virtual image and the observer 100 may also be shorter than infinity. Said distance may be, for example, in the range 1 to 2 meters. Distances shorter than infinity may be implemented using a curved diffractive beam expander disclosed in a patent application PCT/IB2004/004094. Said diffractive beam expander comprises at least one non-planar diffractive element having a finite curvature radius.

A patent application PCT/FI2003/000948 discloses a split diffractive grating element to balance diffraction efficiency with respect to variations in the angle of incidence. It is advantageous to use such an element in the diffractive beam expander 10.

Light escapes from the second diffractive element 14. Advantageously, the local diffraction efficiency of the second diffractive element 14 is adjusted to provide uniform intensity. Otherwise the intensity would be substantially higher at positions near the first diffractive element 12 than at positions far from the element 12.

The beam emitted from the optical engine 20 may also be expanded in the direction parallel to the dimension W1. In that case a third diffractive element may be used. A beam expander based on three diffractive elements is disclosed in a patent application PCT/IL99/00183.

A patent application US2004/0062502 discloses a beam expander with one or more surface interfaces to improve color uniformity in the beam expander, e.g. when expanding red, green and blue light beams simultaneously.

The diffractive beam expander may be implemented using periodic surface relief patterns. The diffractive beam expander may also be a holographic diffractive beam expander, comprising periodic absorbing and non-absorbing features, implemented by holographic manufacturing techniques.

The micro-display 22 may be a reflective, emissive or transmissive two-dimensional light-modulating array. The micro-display 22 may be an array of light emitting diodes (LED, Organic Light Emitting Diode), an array of micromechanical mirrors (MEMS display), or an array of liquid crystal cells (liquid crystal on silicon). The micro display 22 may also be implemented using opto-mechanically scanned light beams, e.g. using a modulated light beam, which is deflected and/or shifted by rotating mirrors.

Micro-displays 22 that are not self-illuminating, such as the MEMS display, require an additional light source. The light source may be integrated into the system. Alternatively, light may be introduced using a waveguide.

Advantageously, the micro-display 22 provides a resolution of 640×400 pixels (VGA display), or a higher resolution. The micro-display 22 is controlled by a control unit (not shown) to display a page of text and/or figures.

The imaging optics 24 comprises advantageously an achromat. Also a lens system comprising several lenses, e.g. a Hastings triplet may be used. The imaging optics 24 may also be implemented using a diffractive element. Said collimating diffractive element may also act as a part of the diffractive beam expander 10.

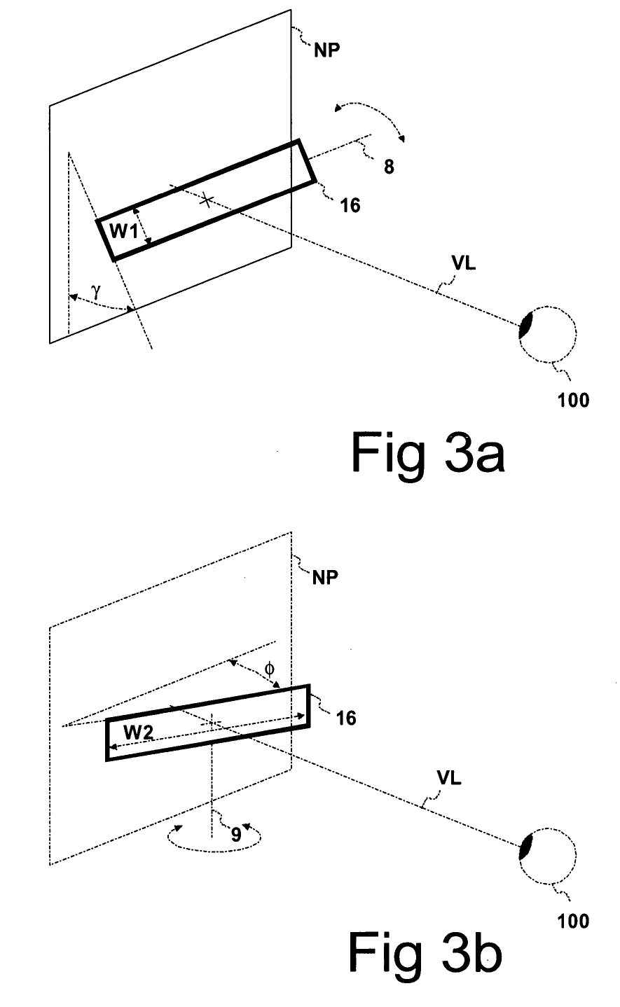

Referring to FIG. 3a, the exit aperture 16 may be tilted with respect to a horizontal axis 8. The center of the exit aperture 16 and the eye of the observer 100 define a viewing line VL and a plane NP perpendicular to said viewing line VL. The dimension W1 of the exit aperture and the plane NP define an angle γ.

Referring to FIG. 3b, the exit aperture 16 may be tilted with respect to a vertical axis 9. The dimension W2 of the exit aperture and the plane NP define an angle φ.

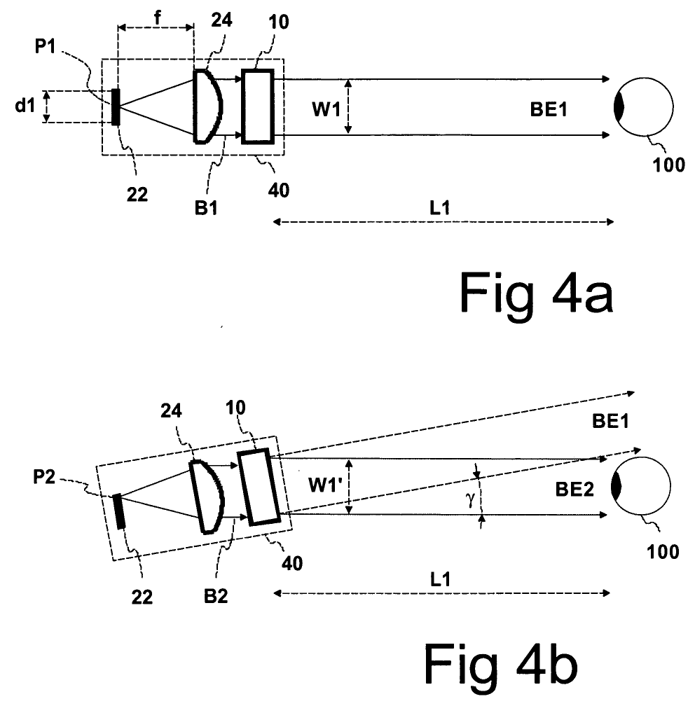

FIG. 4a shows the path of optical rays transmitted from the micro-display 22, as seen from a direction parallel to the dimension W2 of the exit aperture 16. The point P1 is in the center of the active area of the micro-display 22. The point P1 transmits light, which is collimated by the imaging optics 24 to form a collimated beam B1. The collimated beam is transmitted through the beam expander 10 to form an expanded beam BE1. The expanded beam BE1 impinges on the eye of the observer 100, and the observer 100 is able to see a point of a virtual image corresponding to the point P1.

f denotes the focal distance of the imaging optics 24. d1 denotes the dimension of the active area of the micro-display 22 in the direction parallel to the dimension W1 of the diffractive beam expander 10. L1 denotes the distance between the exit aperture 16 and the eye of the observer 100.

FIG. 4b illustrates how the portion of the virtual image visible to the observer 100 is selected by tilting the display module. In FIG. 4b, the angular orientation of the display module 40 with respect to the observer 100 has been changed by the angle γ when compared with the orientation shown in FIG. 4a. Now, the light beam BE1 originating from the point P1 shown in FIG. 4a does not impinge on the observer's eye 100, whereas a second light beam BE2 originating from a second point P2 impinges on the observer's eye 100. Thus the observer is able to see a point of the virtual image corresponding to the point P2, but not a point of the virtual image corresponding to the point P1.

The projection of the exit aperture 16 on a plane normal to the viewing line VL has height W1′ and width W2′ (W2′ is not shown in FIG. 4b). Said dimensions of the projection define the portion of the virtual image visible to the observer 100. W1′ is equal to W1 multiplied by cos(γ). W2′ is equal to W2 multiplied by cos(φ). (See FIG. 3b)

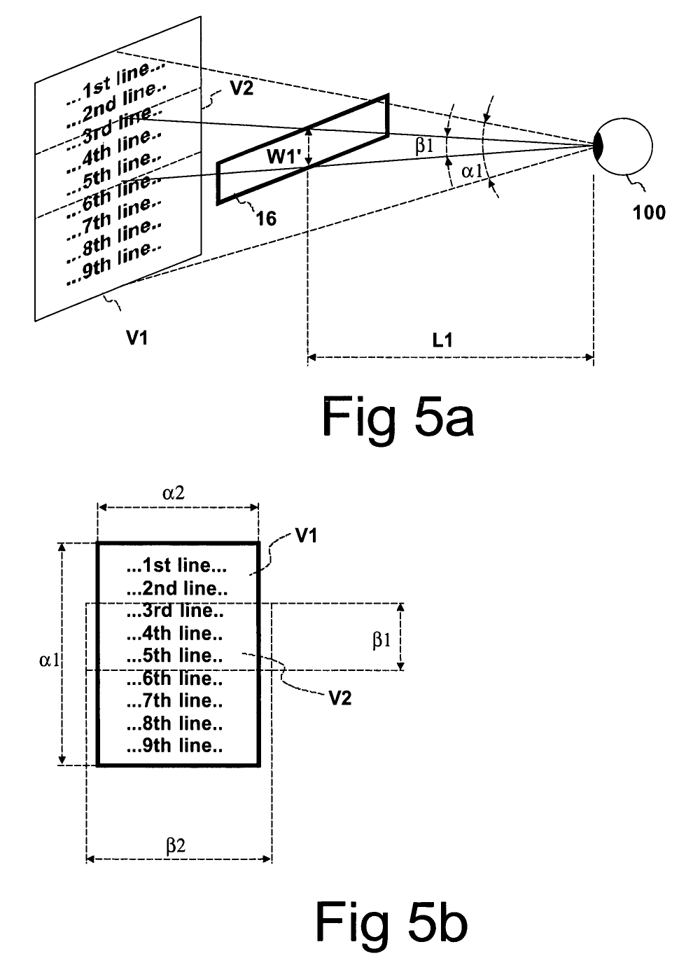

Referring to FIG. 5a, the observer 100 sees the displayed virtual image V1 through the exit aperture 16.

When the virtual image V1 is formed at infinite distance, it does not have dimensions that could be expressed using units of length, i.e. in meters. However, the observer 100 perceives the features of the virtual image V1 in terms of angular dimensions, i.e. in radians or degrees.

The angular dimensions of the virtual image V1 are defined by the dimensions of the active area of the micro-display 22. The height and the width of the active area of the micro-display 22 are d1 and d2 (see FIGS. 2 and 4a). The focal length of the imaging optics 24 is f (FIG. 4a). The angular height α1 of the virtual image is substantially equal to the height d1 of the active area of the micro-display 22 divided by the focal distance f of the imaging optics 24.

Referring to FIG. 5b, the angular width α2 of the virtual image is substantially equal to the width d2 of the active area of the micro-display 22 divided by the focal distance f of the imaging optics 24.

The aspect ratio of the virtual image V1 is defined to be the ratio of the angular width α2 to the angular height α1. Thus, the angular height α1 of the displayed virtual image V1 is equal to d1/f and the angular width α2 of the displayed virtual image V1 is equal to d2/f. Thus, the aspect ratio of the virtual image V1 is equal to d2/d1.

The projected dimension W1′ of the exit aperture 16 defines a portion V2 of the virtual image V2 visible to the observer 100. The maximum angular height β1 of said visible portion V2 is defined by the ratio W1′/L1. The maximum angular width β2 of said visible portion V2 is defined by the ratio W2′/L1, respectively.

The portion V2 can be selected by changing the angular orientation of the display module 40 with respect to the eye of the observer 100. β1 and/or β2 becomes zero, when the tilting angle γ or φ of the display module 40 is too large.

Advantageously, the observer 100 sees the virtual image V1 at a distance, which is in the range from 1 meter to infinity. Thus, a change of the distance between the exit aperture 16 and the observer 100 does not require significant accommodation of the observer's eye. However, in general, people prefer to keep objects at a distance from their eyes. Advantageously, the distance L1 between the exit aperture 16 and the observer 100 is in the range 0.2 to 0.6 meters.

It is advantageous to select the dimensions W1, W2 of the exit aperture such that the size of the exit aperture 16 corresponds to two or three lines of text having a font size of 12 points. The dimension W1 is advantageously 10 mm. The dimension W2 is advantageously an order of magnitude greater than the dimension W1, allowing two or three entire lines of text to be visible at a glance, when the distance L1 is in the range 0.2 to 0.6 meters.

According to the present invention, the aspect ratio of said virtual image V1 is substantially different from the aspect ratio of said exit aperture 16. In other words, the ratio of the first angular dimension α1 of said virtual image V1 to the second angular dimension α2 of said virtual image V1 is substantially different from the ratio of the first dimension w1 of said exit aperture 16 to the second dimension w2 of said exit aperture 16. The expression “substantially different” means that the ratio of the aspect ratio of the virtual image V1 to the aspect ratio of the exit aperture is outside the range 0.5 to 2. Thus, a virtual widescreen image V1 with 16:9 aspect ratio viewed through a 10:1 exit aperture 16 belongs into the category “substantially different”, but a virtual widescreen image V1 with 16:9 aspect ratio viewed through a 1:1 exit aperture 16 does not fall into said category.

When determining the aspect ratio, the substantially uniform light-transmitting area should be considered. For example, when two 5 cm×1 cm exit apertures 16 are positioned next to each other, the substantially uniform exit aperture has dimensions 10 cm×1 cm and a respective aspect ratio of 10:1.

Advantageously, the aspect ratio of the exit aperture 16 is greater than or equal to 10:1, or when oriented vertically, the aspect ratio is smaller than or equal to 1:10.

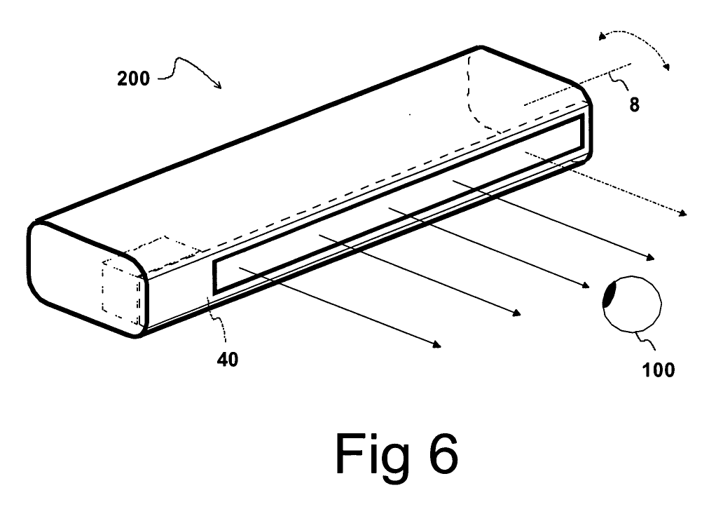

Referring to FIG. 6, a portable device 200 may comprise a display module 40 according to the present invention. The observer 100 may select the visible portion V2 of the virtual image V1 by tilting the device 200, for example around the axis 8. The diffractive beam expander 10 has small dimensions, and therefore the device 200 may be very compact. Advantageously, the device 200 is a slim pen-type device, which is easy to carry in a pocket and easy to handle.

The device 200 may be, for example, selected from the following list: a display module connectable to a further device, portable device, device with wireless telecommunicating capabilities, imaging device, image scanner, digital camera, mobile phone, gaming device, music recording/playing device (based on e.g. MP3-format), remote control transmitter or receiver, wrist watch, compass, heartbeat monitoring device, medical instrument, measuring instrument, industrial measuring instrument, process control device, target finding device, aiming device, navigation device, personal digital assistant (PDA), communicator, portable internet appliance, hand-held computer, accessory to a mobile phone

The device 200 may comprise two or more display modules 40 to enlarge the effective exit aperture 16. The device 200 may comprise a display module 40 for the left eye and a second display module 40 for the right eye of an observer 100. The device 200 may also comprise two separately controlled display units 40 to display three-dimensional images.

The micro-display 22 is operatively connected to a controlling unit (not shown), which provides controlling signals to the micro-display 22. The displayed image may be a still image or a moving image. The device 200 may also comprise battery, telecommunicating unit, control buttons, keyboard, audio devices, data storage units etc.

Advantageously, the micro-display 22 is able to display e.g. Latin, Arabic or Chinese alphabets. When viewing vertically oriented text, e.g. typical Chinese writing, the device 200 may be held vertically. The device may have at least two different modes of operation, one for horizontal text and one for vertical text.

A mask with an aperture may be positioned over the diffractive beam expander 10 to protect the surface and to enhance the visual appearance of the device 200. The mask may slightly reduce the dimensions of the exit aperture 16.

The display module 40 may comprise elements to affect the angular height α1 of the virtual image V1 irrespective of the angular width α2, and vice versa. The display module 40 may comprise further reflecting or image rotating elements to optimize the use of available space in the device 200

Advantageously, the entire display module 40 or the entire portable device 200 is tilted. However, for the selection of the visible portion, it is sufficient to tilt only the combination of the micro-display 22 and the imaging optics 24.

The exit aperture 16 may also have another form than a rectangular form. For example, it may be ellipsoidal, it may have rounded corners or it may even have a rhombic form to create a fancy impression. In those cases the dimension W1 of the exit aperture refers to the greatest dimension of the exit aperture 16 and the dimension W2 refers to the dimension perpendicular to the dimension W1, allowing the aspect ratio W2/W1 to be defined.

It is also possible to hold the display module 40 near the eye of the observer, i.e. within a distance less than 3 cm. In that case the display module 40 acts as a near-eye-display.

For the person skilled in the art, it will be clear that modifications and variations of the devices and method according to the present invention are perceivable. The particular embodiments described above with reference to the accompanying drawings are illustrative only and not meant to limit the scope of the invention, which is defined by the appended claims.

What is claimed is:

1. A method to display a virtual image, said method comprising at least forming a virtual image by a micro display, imaging optics, and a diffractive beam expander, said virtual image being an image of an active area of said micro display, and said virtual image being observable through an exit aperture of said diffractive beam expander, wherein the virtual image has an aspect ratio and the exit aperture has an aspect ratio, and further wherein the aspect ratio of said virtual image is substantially different from the aspect ratio of said exit aperture.

2. The method according to claim 1, wherein the ratio of the aspect ratio of said virtual image to the aspect ratio of said exit aperture is outside the range 0.5 to 2.

3. The method according to claim 1, wherein a visible portion of said virtual image is selected by changing the angular orientation of a combination of said micro display and said imaging optics with respect to an observer.

4. A display module to form a virtual image, said display module comprising at least a micro display, imaging optics and a diffractive beam expander, said virtual image being an image of an active area of said micro display, and said virtual image being observable through an exit aperture of said diffractive beam expander, wherein the virtual image has an aspect ratio and the exit aperture has an aspect ratio, and further wherein the aspect ratio of said virtual image is substantially different from the aspect ratio of said exit aperture.

5. The display module according to claim 4, wherein the ratio of the aspect ratio of said virtual image to the aspect ratio of said exit aperture is outside the range 0.5 to 2.

6. The display module according to claim 4, wherein a visible portion of said virtual image is adapted to be selected by changing the angular orientation of a combination of said micro display and said imaging optics with respect to an observer.

7. A portable device comprising a display module to form a virtual image, said display module in turn comprising at least a micro display, imaging optics and a diffractive beam expander, said virtual image being an image of an active area of said micro display, and said virtual image being observable through an exit aperture of said diffractive beam expander, wherein the virtual image has an aspect ratio and the exit aperture has an aspect ratio, and further wherein the aspect ratio of said virtual image is substantially different from the aspect ratio of said exit aperture.

8. The portable device according to claim 7, wherein the ratio of the aspect ratio of said virtual image to the aspect ratio of said exit aperture is outside the range 0.5 to 2.

9. The portable device according to claim 7, wherein a visible portion of said virtual image is adapted to be selected by changing the angular orientation of a combination of said micro display and said imaging optics with respect to an observer.

10. The portable device according to claim 7, wherein said device comprises wireless telecommunication capabilities.
